(19) United States
(12) Patent Application Publication
(10) Pub. No.: US 2005/0030730 A1
(43) Pub. Date: Feb. 10, 2005

(54) Light guide plate, surface light source device and image display

(75) Inventors: Shingo Ohkawa, Misato-shi (JP); Tsutomu Arihara, Saitama-shi (JP); Susumu Kojima, Saitama-shi (JP)

Correspondence Address: STAAS & HALSEY LLP, SUITE 700, 1201 NEW YORK AVENUE, N.W., WASHINGTON, DC, 20005, US

(73) Assignee: ENPLAS Corporation, Kawaguchi (JP)

(21) Appl. No.: 10/855,348

(22) Filed: May 28, 2004

(30) Foreign Application Priority Data
May 28, 2003 (JP) 150367/2003

(51) Int. Cl. F21V 7/04

(52) U.S. Cl. 362/31

(57) ABSTRACT

Provided is a light guide plate having a simple structure that allows an effective emission area to be large and shows a reduced unevenness in brightness in an emission region near to an incidence side face as well as a reduced dropping in brightness in an emission region remote from the incidence side face. The light guide plate is used to provides a surface light source device and an image display employing the device for illuminating an image display panel. In the incidence side face of the light guide plate, a generally central region is formed of a high light dispersing ability area (rough area). The high light dispersing ability area is sandwiched by low light dispersing ability areas (flat and smooth areas or rough areas having a small surface roughness). The high light dispersing ability area is formed in a range including a region irradiated by a center LED of three LEDs.

### BACKGROUND

1. Field of Invention

The present invention relates to a light guide plate of so-called side-light-type introducing light sideways, a surface light source device and a image display employing the surface light source device for illuminating.

2. Related Art

known typical image display is a liquid crystal display (LCD). The liquid crystal display is, for instance, composed of a liquid crystal display panel and surface light source device illuminating the panel. So-called side-light-type surface light source devices are broadly used. A side-light-type surface light source device is provided with a light guide plate that is supplied with primary light sideways and has an incidence side face in the vicinity of which a primary light source is disposed. Point-like light sources such as LEDs may be adopted as a primary light source.

According to a known manner, three or more point-like light sources are disposed along a width direction of a light guide plate at predetermined intervals to provide a primary light source. Side-light-type surface light source devices are thin-structured easily, being broadly employed as backlights for compact electronic devices such as laptop personal computers, digital cameras or portable phones.

FIG. 16 is a plan view illustrating a surface light source device in accordance with a prior art. Referring to FIG. 16, a plurality of point-like light sources 102 are disposed at regular intervals in the vicinity of side face 101 of light guide plate 100.

Dark portions 103 appear on an emission face because point-like light sources 102 emit light provided with directivity. Dark portions 103 are apt to be triangles formed corresponding to regions between point-like light sources 102 adjacent to each other. Accordingly, an area 104 in the vicinity of side face 101 fails to be suitable for providing an effective light emitting area because of a conspicuous unevenness in brightness generated. In other words, an area 105 excluding region area 104 is employed as an effective light emitting area.

FIG. 17 shows an prior art for eliminating such an unevenness in brightness. Referring to FIG. 17, light guide plate 200 has a side face on which a plurality of concave grooves 202 accommodating point-like light sources 201 respectively for setting the point-like light sources, wherein V-like grooves 203 are formed between concave grooves 202 adjacent to each other (Tokkaisho 6-51130(P)).

As indicated by a dotted-arrow, concave grooves 202 have a light dispersing function and surfaces forming grooves 203 have a light reflection function. Uniformalizing of brightness is aimed by means of these functions.

Another conventional light guide plate has a side face on which grooves are formed as to get shallower according to approach to an emission face. The grooves almost disappear in the vicinity of the emission face. Point-like light sources are disposed close to the emission face and light from the point-like light sources impinge on shallow bottom parts of the grooves, thereby preventing the light from proceeding straightly to the emission face (Tokkai 2000-306411(P)).

FIG. 18 shows an prior art that employs a light guide plate having an incidence side face provided with no grooves. Referring to FIG. 18, a plurality of point-like light source 301 face to a side face of light guide plate 300 and the whole side face provides rough face 302 (Tokkai 2001-243825(JP)).

According to the prior art shown in FIG. 17, the concave grooves 202 accommodating point-like light sources 201 are formed as to across the whole thickness of light guide plate 200. This brings a problem such that light emitted from the point-like light sources 201 goes through toward a not shown liquid crystal display panel (to an emission direction) from end portions (end portions in the emission face side) of concave grooves 202.

If light from point-like light source 201 goes through to the liquid crystal display panel side directly without passing light guide plate 200 as above, trouble such as appearance of bright points arise. This gives the liquid crystal display panel a reduced display performance.

Moreover, according to the prior art shown in FIG. 17, concave grooves 202 formed of the same configuration give incidence side face corners (around both ends of the incidence side face) of light guide plate 200 a lower brightness as compared with that of a central portion on the side of the incidence side face. This can fail to meet performance that liquid crystal displays require.

Still moreover, according to the prior art shown in FIG. 17, since point-like light sources 201 are accommodated and disposed in concave grooves 202 and V-like grooves 203 are formed between concave grooves 202 adjacent to each other, the corers around both ends of the incidence side face of light guide plate 200 is prevented from receiving light from a point-like light source 201 adjacent to the point-like light source 201 corresponding thereto because of being obstructed by grooves 203. Aa a result, light guide plate 200 has a great unevenness in brightness, in particular, unevenness in brightness between the center portion and the corners around both ends of the incidence side face and tends.

In addition, since point-like light sources 201 are accommodated in concave grooves 202, arises a problem such that light guide plate 200 has a reduced resultant emission area (effective light emitting area).

Next, according to the prior art shown in FIG. 18, although uniformalized brightness is realized on the side of the incidence side face (sections P1 to P4 in FIG. 19) of light guide plate 300 because the light emitted from point-like light sources 301 are dispersed at incidence side face (rough face) 302, arises a problem such that brightness decrease in sections P5 to P12 in FIG. 19 according to an increasing distance from the incidence side face.

### OBJECT AND SUMMARY OF INVENTION

The present invention overcomes the above-described problems of prior arts. An object of the present invention is to provide a simply structured light guide plate which can diminish unevenness in brightness appearing on an emission face in the vicinity of an incidence side face and reduction in brightness in an area far from the incidence side face and further can have a large effective light emitting area.

Another object of the present invention is to provide a surface light source device employing this light guide plate.

Still another object of the present invention is to provide an image display employing the surface light source device.

In the first place the present invention is applied to a light guide plate which has an emission face provided by a major face, a back face opposite with said emission face and a side face for light-taking along which at least three point-like light sources are disposed like a line in a width-direction of said side face.

According to a feature of the present invention, said side face includes a center region providing a high light dispersing ability area having a light dispersing ability higher than that of both regions sandwiching said center region.

The present invention is also applied to a light guide plate which has an emission face provided by a major face, a back face opposite with said emission face and a side face for light-taking along which at least three point-like light sources are disposed like a line at predetermined intervals in a width-direction of said face.

According to another feature of the present invention, said side face includes a predetermined region to which a point-like light source located at the middle of said line is directed, said predetermined region providing a high light dispersing ability area having a light dispersing ability higher than that of low light dispersing ability areas provided by both regions sandwiching said predetermined region.

According to still another feature of the present invention, said side face includes a region and another region to one of which a point-like light source located at an end of said line is directed and the other of which another point-like light source located at the other end of said line is directed, and an area covering one of said regions and another area covering the other region respectively provide low light dispersing ability areas sandwiching a high dispersing ability area having a light dispersing ability higher than that of said low light dispersing ability areas.

It is noted that said high light dispersing area may have a surface roughness greater than that of said low light dispersing area. Alternately, said high light dispersing area may be a rough surface and said low light dispersing area is a flat and smooth surface. Further, said high light dispersing area may be formed on said side face as a region in which a plurality of fine grooves run to a plate-thickness direction in parallel to each other.

A surface light source device in accordance with the present invention is provided by combine any of the above light guide plates with three or more point-like light sources disposed like a line in a width-direction of said side face of light guide plate. A liquid crystal display panel illuminated by output light of the surface light source device added thereto provides an image display in accordance with the present invention.

### BRIEF DESCRIPTION OF DRAWING

FIG. 1 is an exploded perspective view of an image display employed in a first embodiment in accordance with the present invention;

FIG. 2a is a plan view of a light guide plate employed in the first embodiment in accordance with the present invention and FIG. 2b is a cross section view of the light guide plate along A-A in FIG. 2a;

FIGS. 3a to d are cross section views along D1-D1 to D4-D4, respectively;

FIG. 4 is a partial perspective view of a main part of the light guide plate employed in the first embodiment;

FIG. 5 is a plan view illustrating light propagation as viewed from an emission face side of the light guide plate employed in the first embodiment;

FIG. 6 is a perspective view of a main part of a first modification of the first embodiment;

FIG. 7 is a perspective view of a main part of a second modification of the first embodiment;

FIG. 8 is a perspective view of a main part of a third modification of the first embodiment;

FIG. 9 is a plan view illustrating an example of brightness distribution of a surface light source device employed in the first embodiment;

FIG. 10 is a plan view illustrating a reference example of a surface light source device for comparison;

FIG. 11 is an exploded perspective view of an image display employed in a second embodiment in accordance with the present invention;

FIG. 12 is a plan view of a light guide plate employed in the second embodiment;

FIG. 13 is a partial perspective view of a main part of the light guide plate employed in the second embodiment;

FIG. 14 is a plan view illustrating light propagation as viewed from an emission face side of the light guide plate employed in the second embodiment;

FIG. 15 is a plan view of a main part of a light guide plate employed in another embodiment;

FIG. 16 is a plan view illustrating a surface light source device in accordance with a prior art;

FIG. 17 is a plan view illustrating a surface light source device in accordance with another prior art;

FIG. 18 is a plan view illustrating a surface light source device in accordance with still another prior art; and,

FIG. 19 is a plan view illustrating a surface light source device in accordance with still further another prior art.

### EMBODIMENT

Embodiments in accordance with the present invention are described below by referring to the drawings. It should be noted that illustration of elements in the drawings is different from actual cases in thickness, relative dimension and others. Actual thickness or dimension is preferably designed under consideration of the description below. It is needles to say that mutual relations of dimensions and ratios of them among drawings are modified in some parts.

### First Embodiment

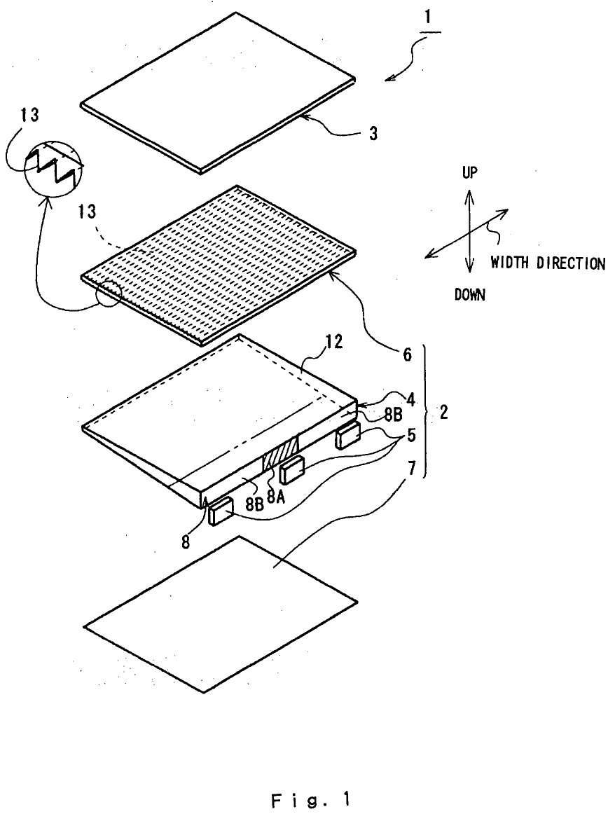

FIGS. 1 to 5 illustrate the first embodiment in accordance with the present invention.

<<Outlined Structure of Image Display>>

Referring to FIG. 1, image display 1 is generally composed of surface light source device 2 and liquid crystal display panel 3 disposed opposite to an emission face of the surface light source device 2.

<Surface Light Source Device>

Surface light source device 2 has a light guide plate 4, three LED s (Light Emitting Diodes) 5 as a point-like light sources disposed opposite to an incidence face (side face) of light guide plate 4, prism sheet 6 overlapped at an emission face side (upper side as shown in FIG. 1 by an arrow) of light guide plate 4 and reflection sheet 7 overlapped at a side opposite to the emission face (lower side as shown in FIG. 1 by another arrow) of light guide plate 4.

(Light Guide Plate)

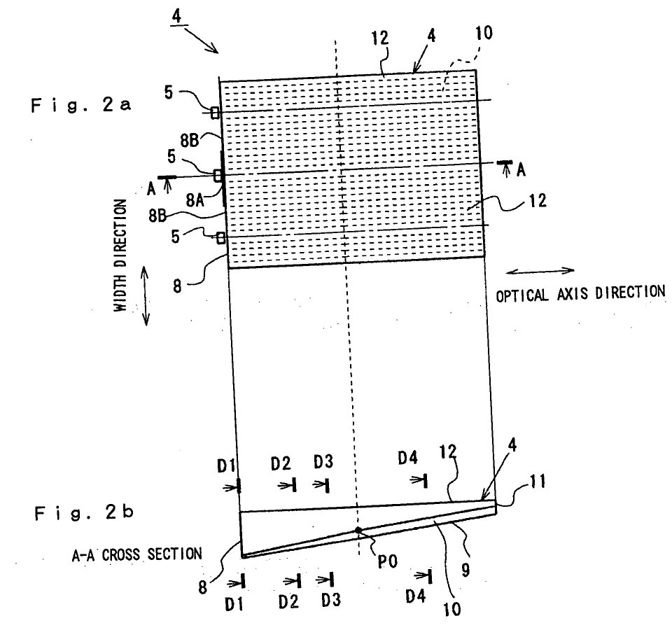

Light guide plate 4 is made of a highly light-permeable material such as PMMA (polymethylmethacrylate), PC (polycarbonate) or cycloolefin-type resin. As shown in FIGS. 1 and 2b, light guide plate 4 has a wedge-like cross section such that plate thickness decreases according to an increasing distance from the side of incidence face 8. A planar shape (shape of emission face) is rectangular. A plurality of prism-like projections 10 are formed on the whole area of back face 9.

Prism-like projections 10 run in a direction approximately vertical to incidence face 8 (optical axis direction), being parallel to each other. Moreover, prism-like projections 10 have the same height in a region starting at a point (P0) distant a predetermined distance along the optical axis direction from incidence face 8 and terminating at a side face 11 opposite to incidence face 8. Further, cross sections of prism-like projections 10 along a plane parallel to incidence face 8 (like triangles) are the same within this region. P1, as shown in FIG. 2b,

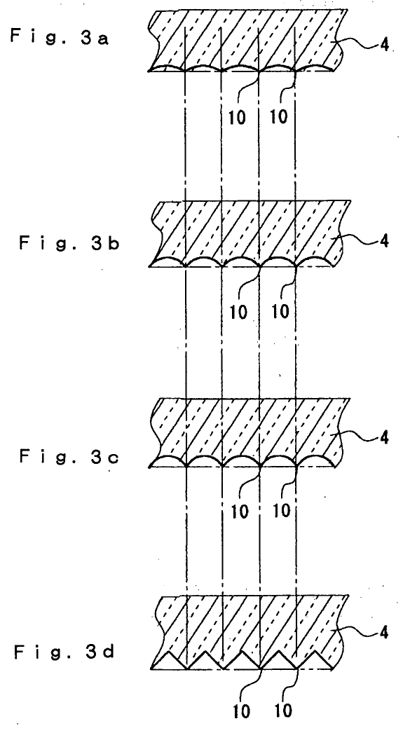

FIGS. 3a to 3d are partial cross section views of light guide plate 4 along D1-D1 to D4-D4 in FIG. 2, respectively, illustrating shape variation of prism-like projections 10 along the optical axis direction.

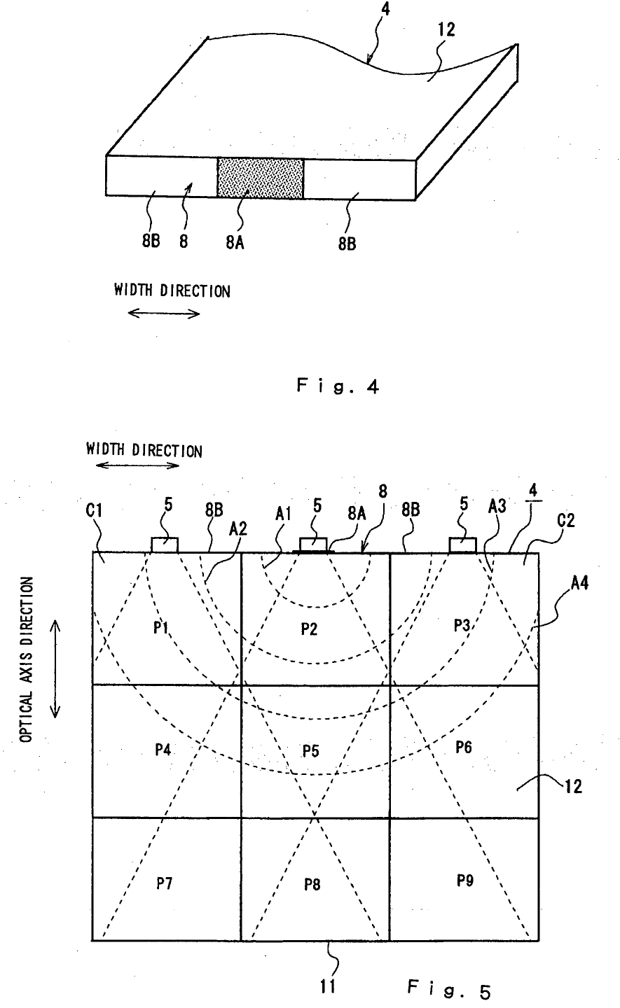

As shown in FIGS. 3a to 3d, height of prism-like projections 10 decreases from the above position (P0) to incidence face 8 and groove shape of them changes smoothly from triangle-like shape to arc-like shape. In this embodiment, as shown in FIGS. 1 and 4, an area approximately central portion in a width direction of incidence face 8 is a high light dispersing ability area. The high light dispersing ability area is provided by mat rough surface 8A.

Both side areas sandwiching rough area 8A on incidence face 8 forms flat and smooth and smooth surfaces 8B as low light dispersing ability areas, respectively. Incidence face 8 disperses light from a central LED 5 to around itself, eliminating unevenness in brightness around area 8A and increasing brightness.

A formation range of rough surface 8A is an area opposite to the center LED of three LEDs 5, preferably, an area illuminated by the center LED. It is noted that this range is determined depending on distance between LED and incidence face 8 as well as emission directivity angle (expanding angle of emitted light).

Actually, width or area of rough surface 8A as high light dispersing ability area may be determined by brightness measurement performed under an arrangement such that three LEDs are disposed at predetermined positions opposite to incidence face 8. That is, brightness may be measured from an emission face side of light guide plate under various conditions of width and area of rough surface 8A and the optimum condition may be determined.

In such ways, this embodiment enables emission face 12 to have a uniformalized brightness. In particular, it is a great advantage that uniformalization of brightness in the vicinity of incidence face 8 on emission face 12 is achieved.

(Prism Sheet)

Prism sheet 6 is a well-known optical element, being rectangular and having approximately the same size as that of emission face 12. A face opposite to emission face 12 has a great number of prism-like projections 13 running in a direction approximately vertical to foresaid prism-like projections 10. Prism sheet 6 has a well-known function. That is, prism sheet 6 redirects an obliquely emitted light from emission face 12 to a direction of normal in a plane perpendicular to incidence face 8. On the other hand, prism-like projections 10 redirect light within light guide plate 4 to a direction of normal in a plane parallel to incidence face 8.

(Reflection Sheet)

Reflection sheet 7 is a known elements, too, being made of a highly reflective material such as white PET. Reflection sheet 7 is rectangular and has approximately the same size as that of back face 9, returning leaking light from back face 9 to the inside of light guide plate 4 to reduce loss of light.

<Liquid Crystal Display Panel>

Liquid crystal display panel 3 is a known element, too. Liquid crystal display panel 3 is a light transmission-type liquid crystal display panel provided with a pair of transparent substrate sandwiching and sealing liquid crystal (not shown) and any of active-matrix-type and passive-matrix-type is employable.

### Effect and Merit of the First Embodiment

Effects and merits of light guide plate 4, surface light source device 2 and image display 1 employed in the above-described embodiment are described as follows.

Light guide plate 4 employed in the embodiment has a rough surface 8A that is a central region of incidence face 8 illuminated by LEDs 5. This enables light emitted from LED 5 located at the central to be dispersed in the vicinity of incidence face 8. Accordingly, unevenness in brightness around incidence face 8 is eliminated and light guide plate 100 can have a large effective light emitting area.

FIG. 5 is a diagram illustrating propagation of light emitted from LED 5 in light guide plate 4. As shown in FIG. 5, an incident light from LED positioned at the central in a width direction of incidence face 8 is dispersed at rough surface 8A, propagating toward all directions, for example, as shown by dotted lines A1 to A4. This causes sections P1, P2 and P3 in the vicinity of incidence face 8 on emission face 12 to show an increased brightness. Moreover, such dispersing gives sections P1, P2 and P3 a reduced unevenness in brightness.

Although section P2 tends to be excessively influenced by incidence from the central-located LED 5, this tendency is relaxed by dispersing effects of rough surface 8A. It is noted that section P2 is influenced by both side sections P1 and P3 indirectly and hardly have an excessively reduced brightness.

On the other hand, although sections P1 and P3 are influenced by incidence from LEDs 5 adjacent to them at both sides respectively, corner portions C1 and C2 tend to have a reduced brightness because no LED is arranged on the outer side in width direction of incidence face 8. However, this tendency is diminished by light emitted from LED 5 and then dispersed (dotted line A4). In such ways, corner portions C1, and C2 is avoided from having a short of brightness and brightness is uniformalized in sections P1, P2 and P3.

Next, sections P4 to P9 distant from incidence are prevented from having a reduced brightness by incidence from two LEDs located both sides, with the result brightness approximately equal to that of sections P1 to P3. It is noted that light from both side LEDs 5 is introduced into light guide plate 4 through flat and smooth surface 8B, propagating to opposite side 11 without being dispersed. Specifically in this embodiment, prism-like projections 10 formed in an optical axis direction on back face 9 prevent an inner propagating light from being expanded in a width direction. However, this effect is relaxed by light dispersed at rough surface 4A.

After all, light guide plate 4 employed in this embodiment can have a uniformalized brightness on emission face 12 by applying a simple processing such that a rough surface 8A is formed on a central portion of incidence face 8. In order to form such rough surface 8A, various methods are applicable. For instance, fine unevenness is formed on a corresponding inner face of a mold or blast processing is applied after being molded.

Emission having a highly uniform brightness from emission face 12 is redirected by prism sheet 6 to approximately frontal direction. High uniformity of brightness is also maintained after being redirected. Accordingly, liquid crystal display panel 3 is illuminated uniformly.

Moreover, since image display 1 provided with such a surface light source device 2 give a small unevenness in brightness to display light passing through liquid crystal display panel 3, display performance is improved. In addition, image display 1 is made compact.

### First Modification of the First Embodiment

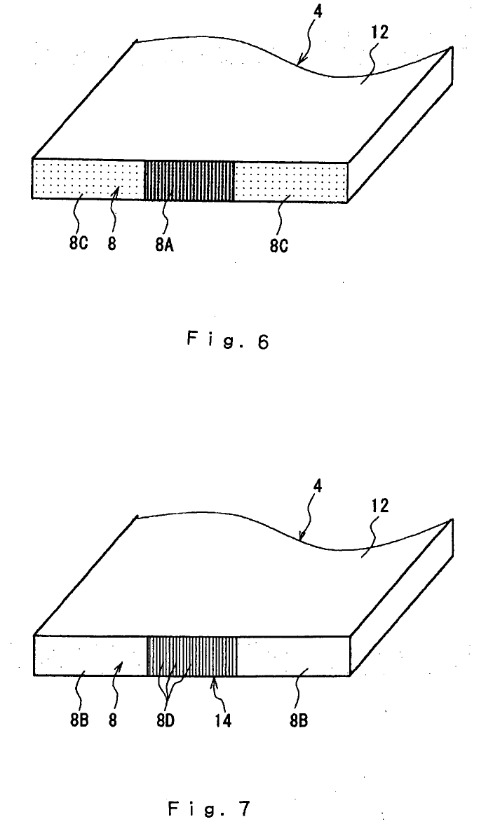

In the above-described first embodiment, the central area of incidence face 8 is rough surface 8A on both sides of which are flat and smooth surfaces 8B. This first modification replaces flat and smooth surfaces 8B with rough surfaces 8C as shown in FIG. 6. Roughness of rough surfaces 8C is smaller than that of rough surface 8A. In other words, rough surface 8A is a high light dispersing ability area and rough surfaces 8C are low light dispersing ability areas. This modification dispersing effects to light from LEDs 5 is heighten as a whole. Brightness is also able to be uniformalized.

### Second Modification of the First Embodiment

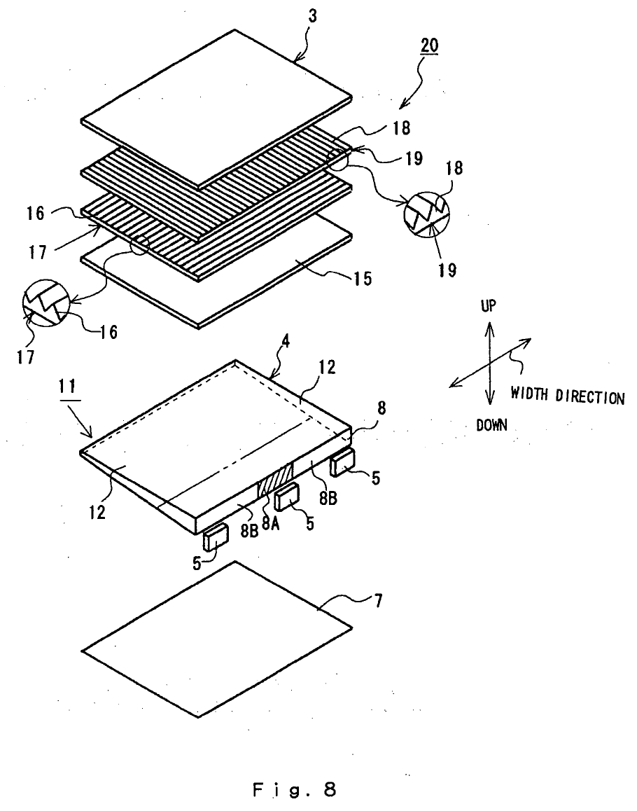

Rough surface 8A in the first embodiment may be replaced by fine groove area 14 as shown in FIG. 7. In fine groove area 14 a plurality of fine grooves 8D are formed as to run in parallel to each other along thickness direction on incidence face 8. In this modification, light emitted from the central LED 5 is dispersed finely at fine grooves 8D, bringing effects similar to those in the first embodiment. It is noted that low light dispersing ability areas sandwiching fine groove area 14 may be provided by numerous fine grooves finer than fine grooves 8D in fine groove area 14.

### Third Modification of the First Embodiment

One prism sheet 6 is interposed between liquid crystal display panel 3 and light guide plate 4 in the first embodiment. This may be modified as FIG. 8 shows. According to this modification, a diffusion sheet 15 is disposed on emission face 12 and first prism sheet 17 is disposed thereon as to direct prism-like projections 16 to liquid crystal display panel 3. Moreover, a second prism sheet 19 is disposed on first prism sheet 17. Prism-like projections 18 of prism sheet 19 are directed to liquid crystal display panel 3 and run approximately vertical to prism-like projections 16.

(Example of Brightness Distribution)

Brightness distribution obtained by surface light source device 2 employed in the first embodiment was measured.

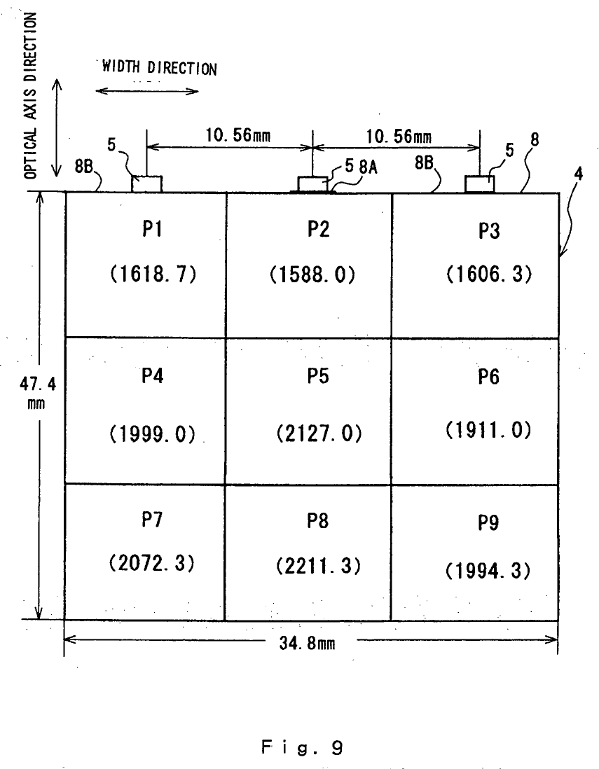

Light guide plate 4, prism sheet 6 nd reflection sheet 7 were the same in planar shape and size. Concretely, size in width direction was 34.8 mm and size in optical axis direction was 47.4 mm as shown in FIG. 9. One LED 5 was disposed at the central position in width direction of incidence face 8 of light guide plate 4. On both sides of central LED 5, LEDs 5 were disposed at intervals of 10.56 mm. Rough surface 8A had a roughness of 0.23 μm in arithmetic mean roughness Ra and flat and smooth surface 8B had a roughness of 0.01 μm in arithmetic mean roughness Ra.

In FIG. 9 sections P1 to P9 are equally divided emission face (emission face of prism sheet 6). LEDs lighted on, brightness was measured at a center of each of sections P1 to P9. Results are shown by bracketed data in cd/m² in each of sections P1 to P9. Averaged brightness of sections P1 to P3 was 1604.3 (cd/m2). Averaged brightness of sections P4 to P6 was 2012.3 (cd/m²) and averaged brightness of sections P7 to P9 was 2092.6 (cd/m²). Averaged brightness of sections P1 to P9 was 1903.1 (cd/m²).

### REFERENCE EXAMPLE

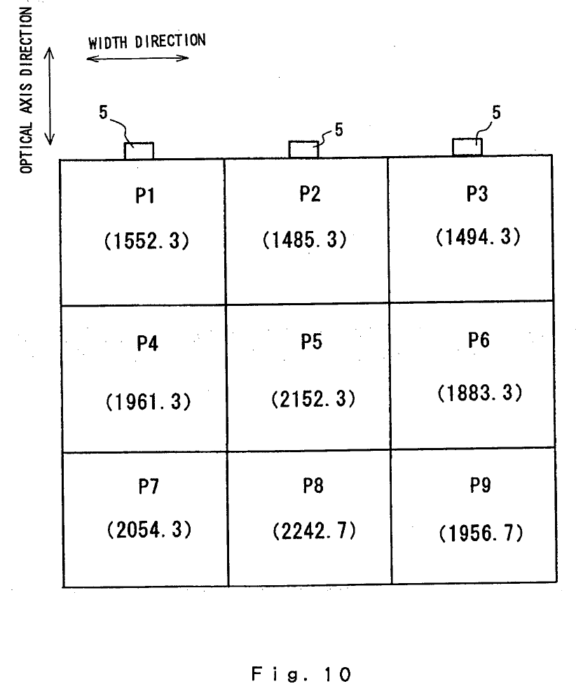

Measurement was carried out under the same condition as the above condition except that incidence face 8 of light guide plate 4 includes no rough surface, being provide with a relatively smooth surface of 0.01 μL m in arithmetic mean roughness Ra. Results are shown in FIG. 10.

In FIG. 9. sections P1 to P9 are equally divided emission face (emission face of prism sheet 6). LEDs lighted on, brightness was measured at a center of each of sections P1 to P9. Results are shown by bracketed data in cd/m² in each of sections P1 to P9. Averaged brightness of sections P1 to P3 was 1510.6 (cd/m²). Averaged brightness of sections P4 to P6 was 1999.0 (cd/m²) and averaged brightness of sections P7 to P9 was 2084.6 (cd/m²). Averaged brightness of sections P1 to P9 was 1864.7 (cd/m²).

Comparing the above measurement example with reference example, average brightness of 1903.1 (cd/m²) of the former is remarkably larger that average brightness of 1864.7 (cd/m²) of the latter. Regarding average brightness in sections P1 and P3, reference example gave 1510.6 (cd/m²) and measurement examples gave 1604.3 (cd/m²), the former is larger than the latter in the vicinity of incidence face 8.

In a similar way, seeing average brightness in sections (intermediate sections) P4 to P6, measurement example gave height brightness as compared with reference example. Moreover, seeing average brightness in sections (remote sections) P7 to P9, measurement example gave height brightness as compared with reference example.

Seeing differences in average brightness among sections (near sections) P1 to P3, sections (intermediate sections) P4 to P6 and sections (remote sections) P7 and P9, measurement example gave smaller values than as compared with reference example.

For instance, difference between sections P7 to P9 giving the highest average brightness and sections P1 to P3 giving the lowest average brightness is 488.3 (cd/m²) in measurement example and 574.0 (cd/m²) in reference example. This demonstrates reduction in brightness changing along an optical axis direction.

Further, since brightness reduction in sections P1 to P3 is diminished, under the same size condition, surface light source device 2 employed in measurement example has a merit such that a larger effective light emitting area can be provided.

Such results tell that a concrete example of light guide plate having a small unevenness in brightness may have rough surface 8A of about 0.23 μm in arithmetic mean roughness Ra and flat and smooth surface s 8B on both sides of about 0.01 μm in arithmetic mean roughness Ra.

### Second Embodiment

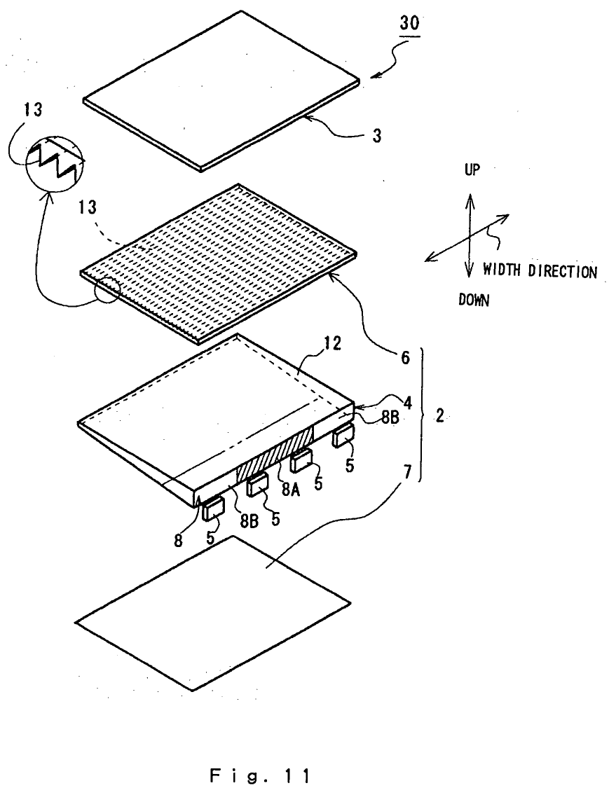

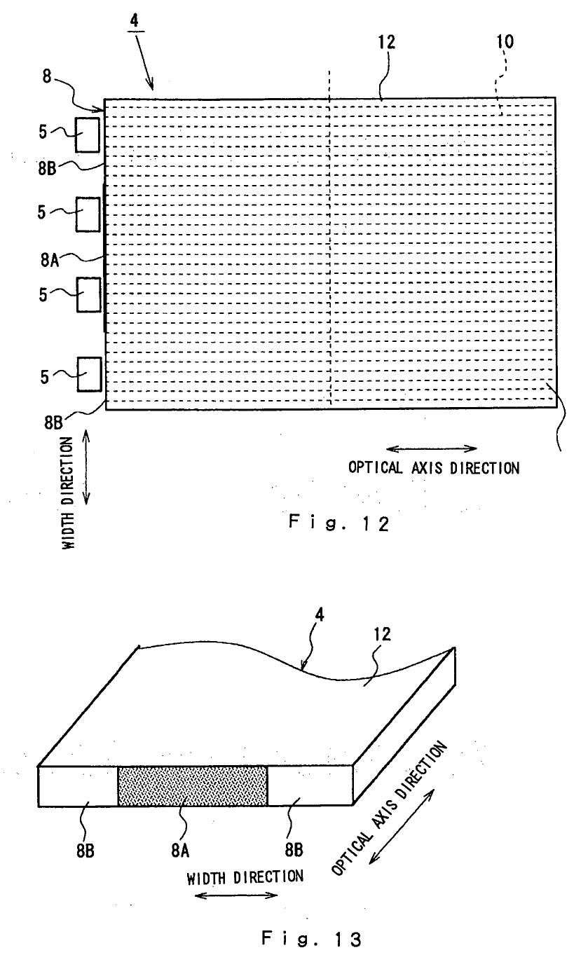

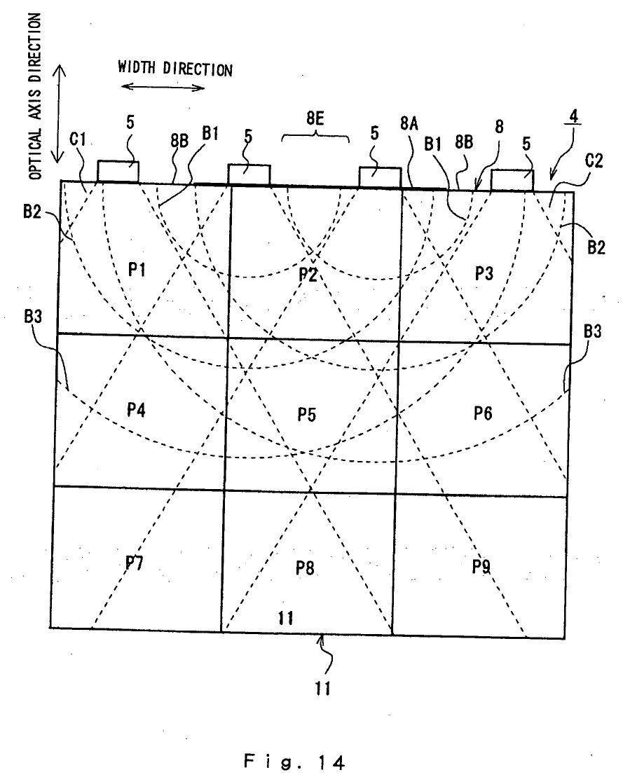

FIGS. 11 to 14 illustrate the second embodiment. FIG. 11 is an exploded perspective view of an image display employed in the second embodiment in accordance with the present invention. FIG. 12 is a plan view of a light guide plate employed in the second embodiment and FIG. 13 is a partial perspective view of a main part of the same light guide plate. FIG. 14 is a plan view illustrating light propagation as viewed from an emission face side of the light guide plate. As for parts commonly employed as compared with the first embodiment, the same reference numerals are used and detailed description on individuals is not repeated.

<<Outlined Structure of Image Display>>

Referring to FIG. 11, image display 30 is generally composed of surface light source device 2 and liquid crystal display panel 3 disposed opposite to an emission face of the surface light source device 2.

<Surface Light Source Device>

Surface light source device 2 has a light guide plate 4, four LED s (Light Emitting Diodes) 5 as a point-like light sources disposed opposite to an incidence face (side face) of light guide plate 4, prism sheet 6 overlapped at an emission face side (upper side as shown in FIG. 1 by an arrow) of light guide plate 4 and reflection sheet 7 overlapped at a side opposite to the emission face (lower side as shown in FIG. 1 by another arrow) of light guide plate 4.

(Light Guide Plate)

Referring to FIGS. 11 to 14, incidence face 8 includes mat rough surface 8A at least covering a central portion illuminated by light in a width direction of incidence face 8 and rough surface 8A provides a high light dispersing ability area. On the other hand, both areas sandwiching rough surface 8A on incidence face 8 are flat and smooth surfaces 8B providing low light dispersing ability areas.

A formation range of rough surface 8A is an area opposite to the center two LEDs of four LEDs 5, concretely, covering an area illuminated by the center two LEDs. Although an area between the central two LEDs (8E in FIG. 14) does not receive light from the two LEDs 5 directly,this area is included in rough surface 8A.

It is noted that the area illuminated by light from the central two LEDs 5 is determined depending on distance between the LEDs and incidence face 8 as well as emission directivity angle.

Actually, width or area of rough surface 8A as high light dispersing ability area may be determined as to find the optimum condition by brightness measurement performed under an arrangement such that four LEDs 5 are disposed opposite to incidence face 8. It is noted that roughness is constant in rough surface 8A.

Such a light guide plate 4 gives emission face 12 a uniformalized brightness. In particular, this embodiment enables brightness on the side of incidence face 8 on emission face to be uniformalized.

(Prism Sheet, Reflection Sheet, Liquid Crystal Display Panel>

Description on prism sheet, reflection Sheet and liquid crystal display panel is omitted because they are the same as those in employed in the first embodiment.

### Effect and Merit of the Second Embodiment

Effects and merits of light guide plate 4, surface light source device 2 and image display 1 employed in the second embodiment are described as follows.

Light guide plate 4 has a rough surface 8A that corresponds to a region illuminated by the central two LEDs 5 of four LEDs 5 illuminating incidence face 8. This enables light emitted from the two LEDs 5 located at the central to be dispersed toward the whole light guide plate 4 as viewed from above emission face 12.

FIG. 14 is a diagram illustrating propagation of light emitted from LED 5 in light guide plate 4.

As shown in FIG. 14, an incident light from the two LEDs positioned at the central in a width direction of incidence face 8 is dispersed at rough surface 8A, propagating toward all directions, for example, as shown by dotted lines B1 to B3. This causes sections P1, P2 and P3 shown in FIG. 14 to show an approximately uniform brightness.

Although section P2 tends to be excessively influenced by incidence from the central two LEDs 5, this tendency is relaxed by dispersing effects of rough surface 8A as compared a case without rough surface 8A. It is noted that section P2 is influenced by both side sections P1 and P3 indirectly and can avoid an excessively reduced brightness.

On the other hand, although sections P1 and P3 are influenced by incidence from LEDs 5 adjacent to them at both sides respectively, no LED is arranged on the outer side in width direction of incidence face 8. This could cause corners C1 and C2 to have a reduced brightness. However, this tendency is cancelled because light emitted from the central two LEDs 5 and then dispersed (dotted line B4 in FIG. 14) reaches C1 and C2. As a result, sections P1 to P3 have a uniformalized brightness.

Sections P4 to P9 distant from incidence have a uniformalized brightness because light emitted from four LEDs 5 reaches after being dispersed.

As described above, light guide plate 4 employed in this embodiment can have a uniformalized brightness on emission face 12 by applying a simple processing to incidence face 8.

Accordingly, surface light source device 2 provided with such a light guide plate 4 outputs emission having a highly uniform brightness through prism sheet 6. As a result, liquid crystal display panel 3 is illuminated uniformly. Moreover, since image display 1 provided with such a surface light source device 2 give a small unevenness in brightness to display light passing through liquid crystal display panel 3, display performance is improved.

### Modification of the Second Embodiment

In the above-described second embodiment, both areas sandwiching rough surface 8A are flat and smooth surfaces 8B. Both flat and smooth surfaces 8B may be replaced by rough surfaces. Roughness of these rough surfaces is smaller than that of rough surface 8A. This makes dispersing effects to light from LEDs 5 stronger and uniformalization of brightness distribution is promoted also able to be uniformalized.

Rough surface 8A in the second embodiment or modification thereof may be replaced by a fine groove area in which a plurality of fine grooves are formed as to run in parallel to each other along thickness direction on incidence face 8. If such a fine groove area is adopted as a high light dispersing ability area, light emitted from the central two LEDs 5 is dispersed finely at fine grooves. As a result, effects similar to those in the second embodiment.

It is noted that not only the central portions but also both areas sandwiching it may be a fine groove area. Such both areas are consist of numerous fine grooves finer than fine grooves in the central high light dispersing ability area.

One prism sheet 6 is interposed between liquid crystal display panel 3 and light guide plate 4 in the second embodiment. This may be modified. That is, in the same manner shown FIG. 8, a diffusion sheet 15 may be disposed on emission face 12 and two prism sheets may be interposed between light guide plate 4 and liquid crystal display panel 3.

<Other Modifications>

The scope of the present invention is not limited by the above-described embodiments and modifications. For example, the following modifications are allowed.

(I) In the above-described first and second embodiments, numbers of LEDs 5 disposed along a width direction of incidence face 8 of light guide plate 4 are three an four, respectively. However, this put no limitation to the present invention. Any number of LEDs more than three may be disposed at predetermined intervals in a line-like arrangement.

(II) Point-like light sources may be other than LEDs. Various light emitting sources are employable.

(III) In the above-described first and second embodiments, one high light dispersing ability area is formed on incidence face 8 as to cover a region illuminated by one or two central-located LEDs.

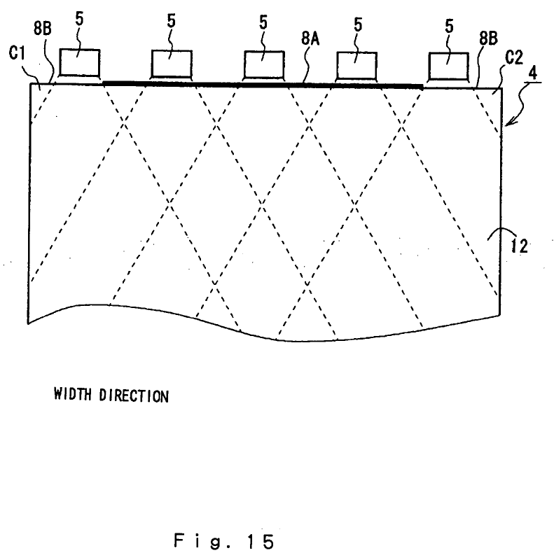

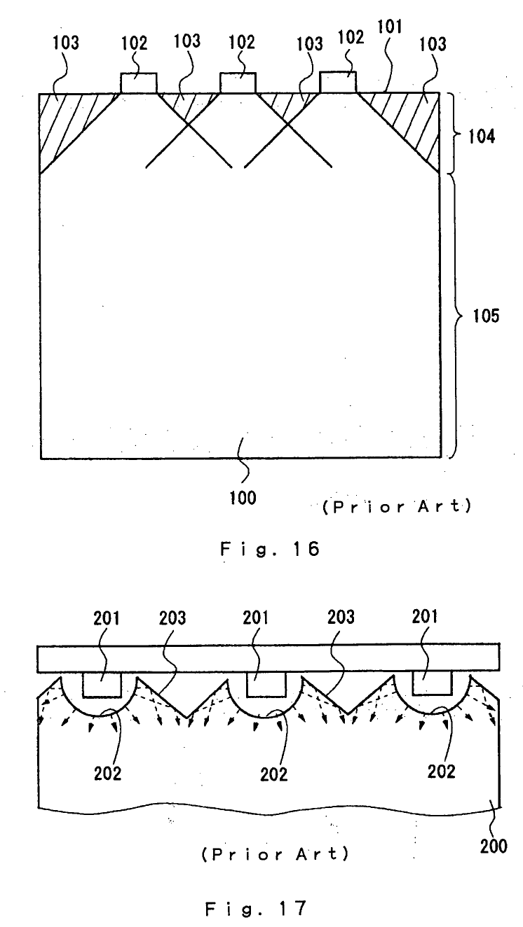

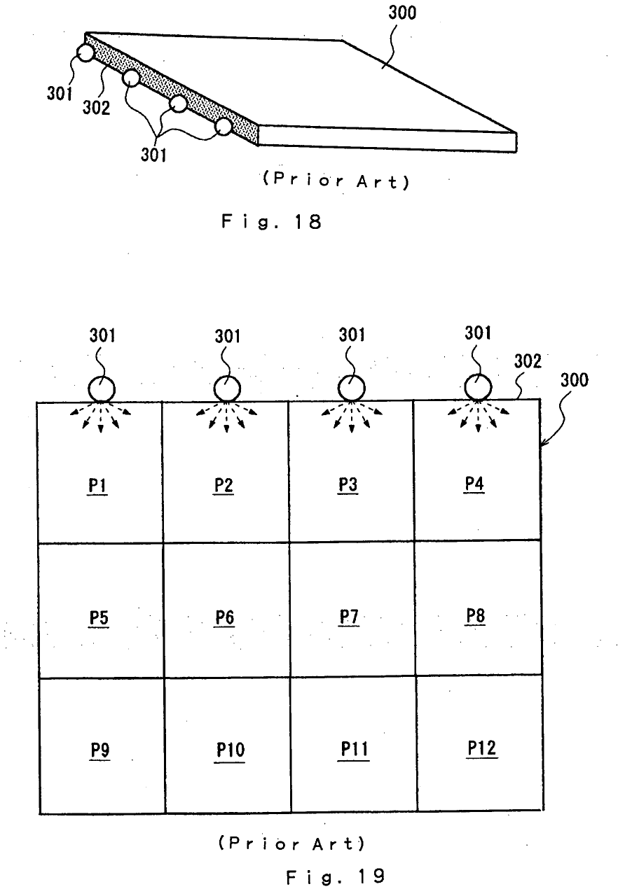

However, this may be modified as shown in FIG. 15 wherein a high light dispersing ability area (rough surface 8A) may be expanded to just near to the inside of a region receiving light from LEDs located both sides in width direction of incidence face 8. If so formed, a promoted diminishing effect can be applied to corners C1 and C2 shown in FIG. 15.

It is noted that similar techniques may be applied to not only the case where five LEDs are disposed as shown in FIG. 15 but also other cases where three, four, six or more LEDs are disposed.

(IV) In the above-described first and second embodiments, point-like light sources are arranged at equal intervals (a constant interval) in a line-like array along an incidence side face. However intervals between adjacent point-like light source may be not constant. That is, “predetermined interval(s)” in the instant specification does not require “constant interval(s)

(V) In the above-described first and second embodiments, light guide plate 4 and surface light source device 2 are combined with liquid crystal display panel 3. However, it is also possible to provide image displays by being combined with various image displaying panels of other kinds.

According to the present invention as described above, reduction in brightness and appearance of unevenness in brightness in the vicinity of an incidence face on an emission face are avoided by applying a simple processing to a light guide plate beside which three or more point-like light sources are disposed. Besides, irregularity in brightness between the vicinity of an incidence face and a remote region from the incidence face is also diminished, improving planar uniformity in brightness of a light guide plate.

As a result, it is possible to provide a surface light source device that give a light guide plate a heightened occupation rato of effective light emitting area of light guide plate. In addition, a compact image display having a good display performance.

1. A light guide plate having an emission face provided by a major face, a back face opposite with said emission face and a side face for light-taking along which at least three point-like light sources are disposed like a line in a width-direction of said side face,
wherein said side face includes a center region providing a high light dispersing ability area having a light dispersing ability higher than that of both regions sandwiching said center region.

2. A light guide plate having an emission face provided by a major face, a back face opposite with said emission face and a side face for light-taking along which at least three point-like light sources are disposed like a line at predetermined intervals in a width-direction of said face,
wherein said side face includes a predetermined region to which a point-like light source located at the middle of said line is directed,
said predetermined region providing a high light dispersing ability area having a light dispersing ability higher than that of low light dispersing ability areas provided by both regions sandwiching said predetermined region.

3. A light guide plate having an emission face provided by a major face, a back face opposite with said emission face and a side face for light-taking along which at least three point-like light sources are disposed like a line at predetermined intervals in a width-direction of said face,
wherein said side face includes a region and another region to one of which a point-like light source located at an end of said line is directed and the other of which another point-like light source located at the other end of said line is directed, and
an area covering one of said regions and another area covering the other region respectively provide low light dispersing ability areas sandwiching a high dispersing ability area having a light dispersing ability higher than that of said low light dispersing ability areas.

4. A light guide plate in accordance with claim 2 or 3, wherein said high light dispersing area has a surface roughness greater than that of said low light dispersing area.

5. A light guide plate in accordance with claim 2 or 3, wherein said high light dispersing area is a rough surface and said low light dispersing area is a flat and smooth surface.

6. A light guide plate in accordance with claim 2 or 3, wherein said high light dispersing area is formed on said side face as a region in which a plurality of fine grooves run to a plate-thickness direction in parallel to each other.

7. A surface light source device comprising:
a light guide plate which has an emission face provided by a major face, a back face opposite with said emission face and a side face for light-taking; and
at least three point-like light sources disposed like a line in a width-direction of said side face,
wherein said light guide plate is a light guide plate in accordance with claim 2 or 3.

8. A surface light source device comprising:
a light guide plate which has an emission face provided by a major face, a back face opposite with said emission face and a side face for light-taking; and
at least three point-like light sources disposed like a line in a width-direction of said side face,
wherein said light guide plate is a light guide plate in accordance with claim 4.

9. A surface light source device comprising:
a light guide plate which has an emission face provided by a major face, a back face opposite with said emission face and a side face for light-taking; and
at least three point-like light sources disposed like a line in a width-direction of said side face,
wherein said light guide plate is a light guide plate in accordance with claim 5.

10. A surface light source device comprising:
a light guide plate which has an emission face provided by a major face, a back face opposite with said emission face and a side face for light-taking; and
at least three point-like light sources disposed like a line in a width-direction of said side face,
wherein said light guide plate is a light guide plate in accordance with claim 6.

11. An image display comprising:
a surface light source device; and
an image display panel illuminated by an output light from said surface light source device,
wherein said surface light source device is a surface light source device in accordance with claim 7.

12. An image display comprising:
a surface light source device; and
an image display panel illuminated by an output light from said surface light source device,
wherein said surface light source device is a surface light source device in accordance with claim 8.

13. An image display comprising:
a surface light source device; and
an image display panel illuminated by an output light from said surface light source device,
wherein said surface light source device is a surface light source device in accordance with claim 9.

14. An image display comprising:
a surface light source device; and
an image display panel illuminated by an output light from said surface light source device,
wherein said surface light source device is a surface light source device in accordance with claim 10.
